(19) United States
(12) Patent Application Publication
(10) Pub. No.: US 2005/0010432 A1
(43) Pub. Date: Jan. 13, 2005

(54) Methods and systems for servicing tires

(76) Inventor: Dustin Ott, South Jordan, UT (US)

Correspondence Address: Kirton & McConkie;1800 Eagle Gate Tower, 60 East South Temple, Salt Lake City, UT, 84111, US

(21) Appl. No.: 10/858,519

(22) Filed: Jun. 1, 2004

Related U.S. Application Data
(60) Provisional application No. 60/474,699, filed on May 30, 2003.

(51) Int. Cl. G06F 17/60

(52) U.S. Cl. 705/1

(57) ABSTRACT

The present invention is a method and system for replacing and servicing a tire that reduces the time and risk traditionally associated therewith. The present method and system contemplates providing a tire selection area located directly above a tire servicing area such that a selected tire may drop directly from the tire selection area to the tire servicing area. The tire servicing area comprises at least one tire servicing lane, each lane incorporating a bridged well on each side sufficient to accommodate a service center employee at an ergonomic level relative to a vehicle. In this manner, a service center employee may service a vehicle's tires comfortably, safely and efficiently.

### RELATED APPLICATION

This application claims priority to provisional application Ser. No. 60/474,699, filed May 30, 2003, entitled “METHODS AND SYSTEMS FOR SERVICING TIRES.”

### BACKGROUND OF THE INVENTION

1. Field of the Invention

The present invention relates to methods and systems for facilitating removal and replacement of automobile tires. In particular, the present invention relates to methods and systems for efficiently and safely changing and rotating automobile tires.

2. Background and Related Art

Traditional tire servicing centers comprise a waiting area in which a customer may wait, sometimes indefinitely it seems, for a vehicle's tires to be repaired, replaced and/or rotated. While the customer waits, servicing center employees may engage in a process of obtaining a brand and size of tire selected by the customer and appropriate for the customer's vehicle, and replacing the customer's worn or damaged tires with such new tires.

Removing and replacing a vehicle's tires is often time consuming, awkward and physically exhausting for servicing center employees. Tire rotation and/or replacement can also be dangerous. Indeed, the size, shape and weight of a vehicle tire and its associated wheel make handling awkward and control difficult. This problem is exacerbated by the position of the tire intermediate the vehicle body and the ground. Implementing a jack between the vehicle body and the ground enables the tire to be effectively removed and replaced, but nevertheless requires an employee to bend or kneel, often at an uncomfortable angle, to effectuate the process. Although industrial vehicle lifts facilitate tire removal and replacement by allowing more clearance between the vehicle and a service center employee, such lifts also present a substantial safety risk. Indeed, a tire prepared for removal may inadvertently fall or be mishandled from a substantial height, thereby increasing the probability and extent of injury resulting therefrom. Further, such industrial lifts may be inefficient due to the increased time and manpower needed to effectively transfer a tire between ground level and the lifted vehicle.

Accordingly, what is needed is a method and system for quickly and efficiently replacing and servicing a tire in order to reduce customer waiting time and servicing center expense. Additionally what is needed is a method and system for replacing and servicing a tire that minimizes physical strain and discomfort of a service center employee. Finally what is needed is a method and system for replacing and servicing a tire that minimizes the risk of injury to a service center employee.

### SUMMARY OF THE INVENTION

The present invention is a method and system for replacing and servicing a tire that reduces the time and risk traditionally associated therewith. The present method and system contemplates providing a tire selection area located above a tire servicing area such that a selected tire may drop directly from the tire selection area to the tire servicing area. The tire servicing area comprises at least one tire servicing lane, which incorporates a well on each side sufficient to accommodate a service center employee at an ergonomic level. In this manner, a service center employee may service a vehicle's tires comfortably, safely and efficiently.

An object of the present invention is to provide a method for replacing and servicing tires quickly and efficiently.

Another object of the present invention is to provide a method for replacing and servicing tires that presents a vehicle at an ergonomic level to reduce physical strain on a service center employee.

A further object of the present invention is to provide a method for replacing and servicing tires that minimizes any risk of injury.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 is a cross-sectional perspective view of one embodiment of a tire servicing center in accordance with the present invention;

FIG. 2 is a plan view of the tire servicing area of FIG. 1;

FIG. 3 is a perspective view of one embodiment of a tire selection area of the present invention;

FIG. 4 is a perspective view of one embodiment of a tire servicing area of the present invention;

FIG. 5 is an operator sequence chart illustrating one embodiment of the method of the present invention;

FIG. 6 is a detailed flow chart of steps that may be followed when selecting a tire in accordance with the method of the present invention; and

FIG. 7 is a detailed flow chart of steps that may be followed when servicing a tire in accordance with the method of the present invention.

### DETAILED DESCRIPTION OF THE INVENTION

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

As used in this specification, the term “ergonomic” refers to a design or arrangement used to increase the safety and efficiency with which a person and thing interact. Specifically, an “ergonomic servicing well” refers to a well having dimensions appropriate to allow safe and efficient interaction between a servicing center employee situated therein and a vehicle to be serviced.

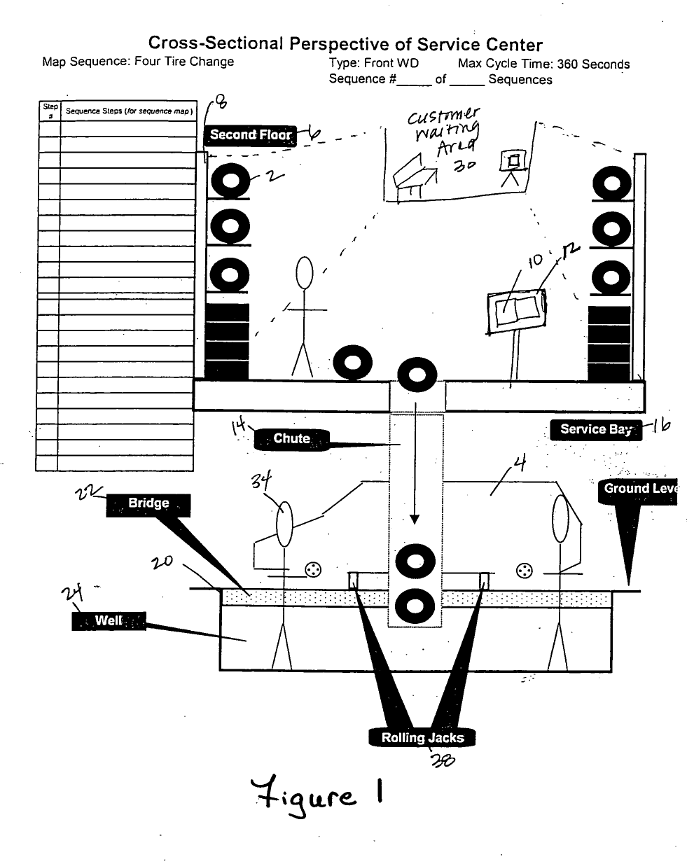

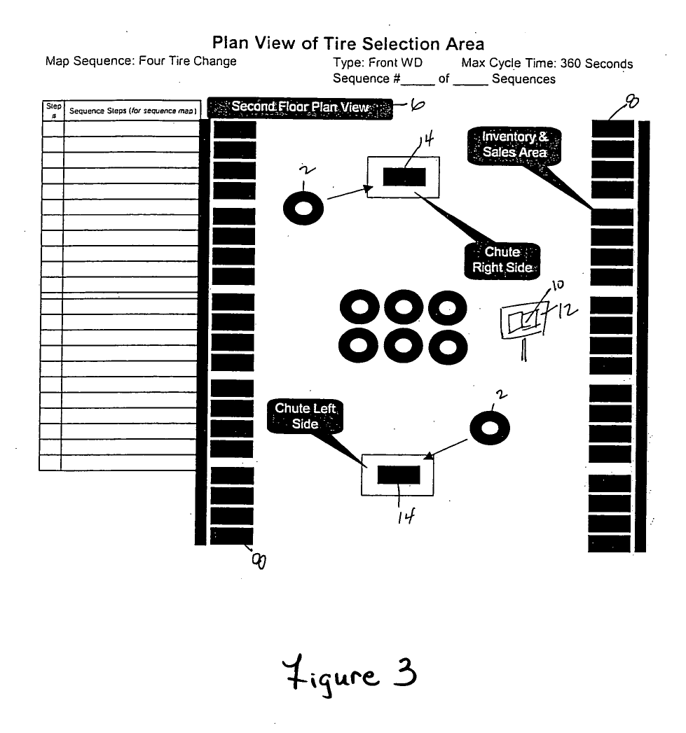

Referring to FIG. 1, one embodiment of the present invention comprises a tire selection area 6 located over, or at a level above and offset from, a tire servicing area 16. A tire selection area 6 may comprise tire retaining elements 8 for stacking, supporting and/or retaining at least one tire 2. A tire retaining element 8 may comprise a pole, cable, shelf, cylinder, hollow housing or any other element known to those in the art capable of retaining and/or supporting at least one tire 2. A tire retaining element 8 may also incorporate a removable or releasable portion such that upon removal or release, such portion allows one or more tires 2 to exit the retaining element 8 and be passively or actively transported to a tire servicing area 16. Transport of one or more tires 2 from a tire selection area 6 may be facilitated by any mechanical, hydraulic, pneumatic or magnetic means, or by any other means known to those in the art, by which to effectuate transfer of a tire 2. Preferably, tire transport is effectuated passively as gravitational forces cause one or more tires 2 to be directed from a second level tire selection area 6 to a tire servicing area 16 below. This aspect of the present invention is discussed in more detail with reference to FIG. 3 below. A tire selection area 6 may also comprise a tire selection index 10 and associated information entry center 12 that a customer may use to identify and select an appropriate tire 2 for the customer's vehicle 4.

According to one aspect of certain embodiments of the present invention, a tire selection area 6 may comprise a tire chute 14 connecting the tire selection area 6 to a tire servicing area 16. A tire chute 14 may comprise a ramp, drop hole, channel, slide, or any other mechanism or structure known to those in the art by which to utilize gravitational forces to transfer a tire 2 from a second level tire selection area 6 to a tire servicing area 16 below.

According to another aspect of certain embodiments of the present invention, a tire selection area 6 may comprise a customer waiting area 30 where a customer may relax or be entertained while waiting for his vehicle 4 to be serviced. Indeed, a customer waiting area 30 may include sofas, chairs, a television, magazines, a radio, a computer, internet access, or any other item or service that may entertain a customer and/or enable a customer to relax while waiting for his vehicle to be serviced. As a tire selection area 6 is preferably located at a level above the tire servicing area 16, a tire selection area 6 may also comprise a plurality of windows such that a customer waiting in the customer waiting area 30 may enjoy the view. A customer waiting area 30 may also incorporate sound-proof insulation to insulate the customer waiting area 30 from loud or disturbing sounds emanating from the tire servicing area 16 below.

According to another aspect of the present invention, a tire servicing area 16 may comprise at least one tire servicing lane 22. By way of example and not limitation, a tire servicing lane 22 may be defined by a bridge proportioned to accommodate the body of a vehicle 4 along its longitudinal axis between each of its front and rear tires 2. Alternatively, a tire servicing lane 22 may be defined superficially by marks painted onto the surface 20 of the tire servicing area 16, or by cones or other items placed thereon. A tire servicing lane 22 may also be defined indirectly by the space separating opposite tire servicing wells 24.

A tire servicing well 24 may comprise an opening or pit in the surface 20 of the tire servicing area 16 that extends substantially parallel and adjacent to a tire servicing lane 22. The length of a servicing well 24 preferably corresponds at least to the length of a vehicle 6 parked on the tire servicing lane 22. In this manner, a service center employee 34 may move freely in a direction parallel the parked vehicle 4 to effectuate service on any same side tires 2. Alternatively, a well 24 may comprise a length just sufficient to accommodate a service center employee 34 in a location adjacent a single tire 2. A well 24 may comprise a depth sufficient to accommodate a service center employee 34 at approximately waist level without impairing the employee's arm and upper body movement, preferably between 3 and 3 ½ feet. Once situated in the well 24, a service center employee 34 may thus enjoy an ergonomic relationship with a vehicle 4 and its affected tires 2. Indeed, a service center employee 34 may raise the vehicle 4 on a jack, loosen the lugs corresponding to an affected wheel and tire assembly, and remove and replace the affected wheel and tire 2, all without having to assume an uncomfortable or strained position.

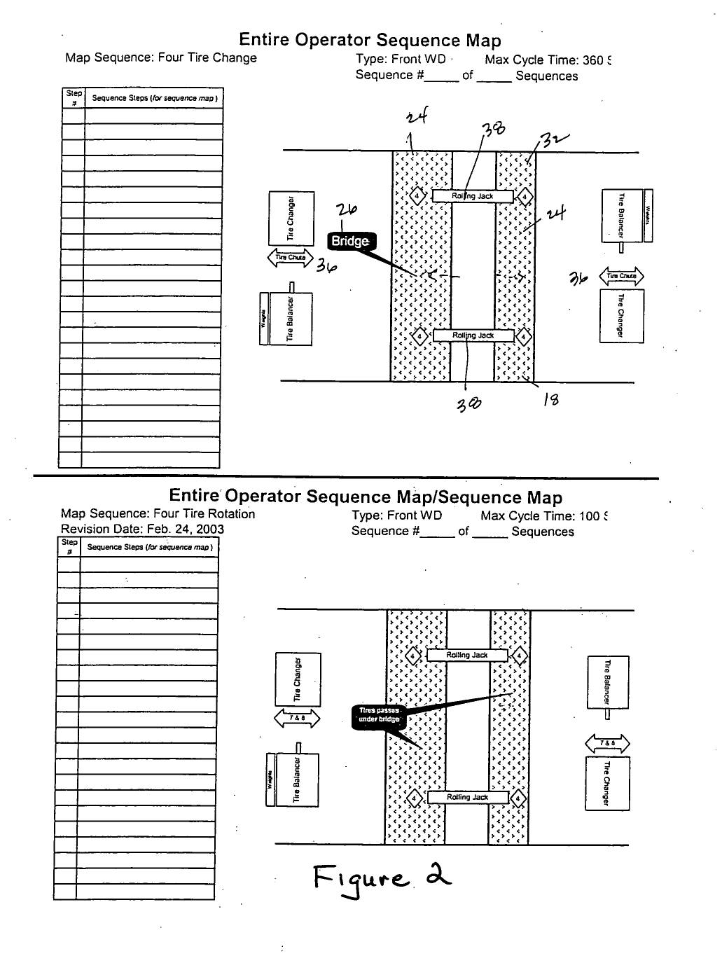

Referring now to FIG. 2, a tire servicing area 16 may further comprise a tire receiving area 36 proximate a tire servicing well 24 such that a service center employee 34 situated in the well 24 may obtain a selected tire 2 without having to exit the well area 24. In addition, a tire receiving area 36 may be connected and/or proximate a point of entry or exit 18 or 32. As a tire servicing well 24 may implement sloped sides at these points as discussed below, physical strain of a service center employee 34 in moving a tire 2 from a receiving area 36 to the tire servicing well 24 may be further reduced. In addition, a ramp may be implemented near a midpoint of a tire servicing well 24, or at any other point along a tire servicing well 24, to facilitate transport of a tire 2 from a receiving area 36 to the tire servicing well 24. Indeed, as certain embodiments of the present invention provide for the selected tire 2 to be passively transferred from the tire selection area 6 to the tire servicing area 16, a receiving area 36 located proximate the tire servicing well 24 enables a service center employee 34 to receive a selected tire 2 while avoiding a majority of the time and physical strain traditionally associated therewith.

The time and physical strain traditionally required of a service center employee 34 may also be reduced by the suspended nature of the bays bridge to facilitate tire rotation and transport of a tire for any other reason. For example, a tire may be passed perpendicularly from the servicing well 24 between a right front tire location and a left front tire location beneath a leveraged vehicle 4. Similarly, a tire may be passed diagonally from a right front tire location to a left rear tire location. In selected embodiments of the present invention, tires may be passed longitudinally, for example, from a right front tire location to a left front tire location, since a servicing well 24 may extend this length, thereby enabling a service center employee to transfer a tire 2 therebetween with minimal physical exertion. Alternatively, a transport channel 26 may run contiguously with opposing tire servicing wells 24, thereby bridging the tire servicing wells 24 to effectively create a unitary tire servicing level.

Referring now to FIG. 3, a tire chute 14 may be interposed between a second or higher level tire selection area 6 and a tire servicing area 16 to facilitate passive transfer of a tire 2 between the two areas 6 and 16. As discussed above with reference to FIG. 1, a tire chute may comprise a ramp, drop hole, channel, slide, or any other mechanism or structure known to those in the art by which to transfer a tire 2. According to one embodiment of the present invention, a tire chute 14 comprises a ramp having substantially rigid sides. The ramp may be set on a decline, such that upon release from a retaining element 8, a tire 2 may passively roll down the tire chute 14 to the tire servicing area 16. According to another embodiment of the present invention, a tire chute 14 comprises a substantially rigid cylindrical element set on a decline between a tire retaining element 8 and a tire servicing area 16, such that upon release from a retaining element 8, the tire 2 may be threaded onto the tire chute 14 and thereby passively guided to the tire servicing area 16. A tire servicing area 16 may incorporate a contained tire receiving area 36 to receive tires 2 that are selected and delivered to the tire servicing area 16.

A tire selection area 6 may also incorporate a tire selection index 10 and/or tire selection entry center 12 to facilitate identifying an appropriate tire 2 for any particular vehicle. According to one embodiment of the present invention, a tire selection index 10 may comprise a table of tire sizes and brands appropriate for a vehicle 4 such that a customer may look up information corresponding to the brand and make of his vehicle 4 and thereby identify an appropriate tire 2 or group of tires from which to select a new tire 2 for his vehicle. A customer 34 may then enter information corresponding to the selected tire 2 into a tire selection entry center 12. The tire selection entry center 12 may be operatively connected to a tire retaining element 8 such that entry of such information causes the appropriate retaining element 8 to release one or more selected tires into a tire chute 14 or other delivery mechanism such that the tire 2 may be received by the tire servicing area 16.

Alternatively, a tire selection entry center 12 may comprise a computer program or other electronic means by which to facilitate tire selection as well as tire delivery. In one embodiment of the present invention, a customer 34 may enter information corresponding to the make and model of his vehicle 4 into the tire selection entry center 12. The tire selection entry center may then suggest tires of a size and brand appropriate for the particular vehicle entered. The customer 34 may then select, by pressing a key, for example, one of the tires identified by the tire selection entry center 12 for delivery of the selected tire to the tire servicing area 16.

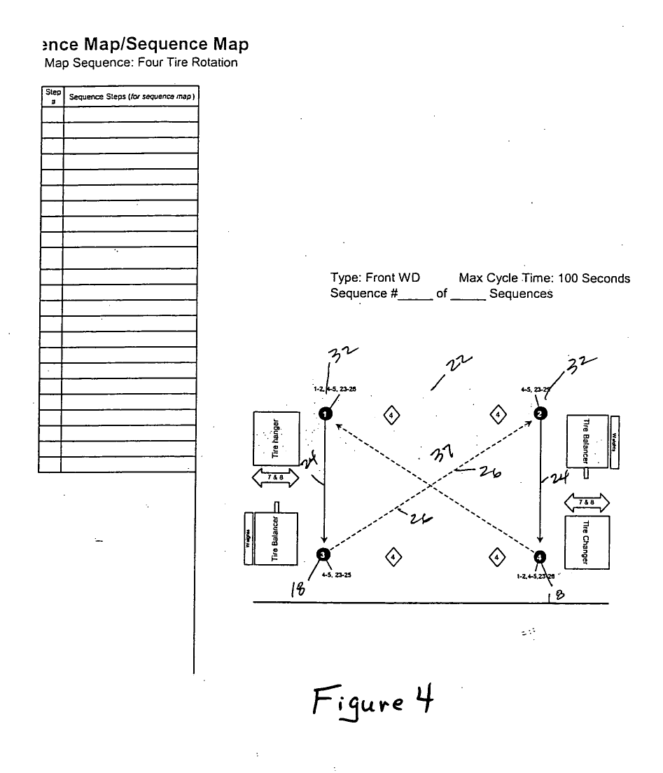

Referring to FIG. 4, a tire servicing lane 22 may incorporate a space 37 sufficient to accommodate a jack 38 to leverage a vehicle above ground level, such that an affected tire 2 may be suspended between the vehicle 4 and the tire servicing area surface 20. In this manner, an affected tire 2 may be removed and replaced as needed by a service center employee 34. According to a preferred embodiment of the present invention, a leveraged vehicle remains substantially centered with the tire servicing lane 22 to prevent injury or damage resulting from any part of an improperly leveraged vehicle 4 inadvertently falling into a servicing well 24. A servicing well 24 may incorporate sloped sides near the tire servicing area's points of entry 18 and exit 32 to facilitate transferring a tire 2 out of a servicing well 24 if one should inadvertently or intentionally be placed therein, and/or to facilitate retrieving a selected tire 2 from a receiving area 36 for installation on a vehicle 4.

As discussed above with reference to FIG. 1, a servicing well 24 may have a depth and width sufficient to accommodate a service center employee 34 at an ergonomic level adjacent a servicing lane 22 and corresponding vehicle 4. A servicing well 24 may also incorporate integrated or attached shelves or other retaining devices to accommodate tools and supplies customarily needed for servicing tires.

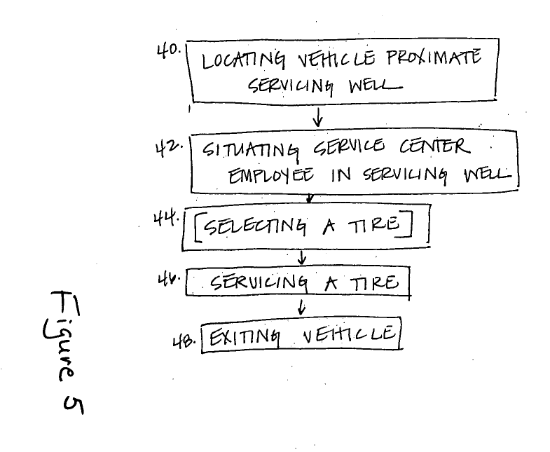

Referring now to FIG. 5, a method in accordance with the present invention may comprise first locating a vehicle proximate a servicing well 24. Locating a vehicle proximate a servicing well 24 may comprise driving a vehicle 4 onto a servicing lane 22 such that the vehicle 4 is substantially aligned with a servicing well 24. Alternatively, locating a vehicle proximate a servicing well 24 may comprise introducing a vehicle 4 onto a device that, when actuated, places the vehicle in an appropriate location relative to a servicing well 24.

A second step of the present method may comprise situating 42 a service center employee 34 at an ergonomic level within the servicing well 24. According to certain embodiments of the present invention, a service center employee 34 may lower himself into the servicing well 24 or may descend into the servicing well 24 via stairs or a ramp integrated or implemented therein. A service center employee 34 may be raised to an ergonomic level within the servicing well 24 by way of a platform or other substantially planar device that may be mechanically or electrically maneuvered to achieve an appropriate ergonomic level for a particular service center employee 34.

A third step of the present method may comprise selecting a tire appropriate for a particular vehicle 44. This step may be achieved by virtue of the methods and systems discussed above with reference to FIGS. 1 and 3, or by any other method known to those in the art. Following selection of an appropriate tire, an affected tire may be serviced and/or replaced as needed 46.

A fifth step of the present method may comprise exiting the vehicle from the tire servicing area 48. This may be accomplished by driving the vehicle 4 through a point of exit 32, or by actuating a device to mechanically move the vehicle past the point of exit 32, as discussed above with reference to the first step of FIG. 5.

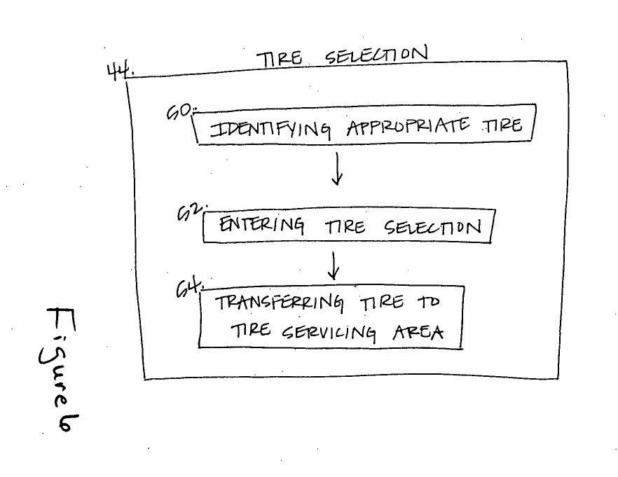

Referring now to FIG. 6, tire selection 44 in accordance with certain embodiments of the present invention may comprise identifying an appropriate replacement tire 50 by way of, for example, locating appropriate tire choices via a tire selection index 10, or entering vehicle information into a tire selection entry center 12, or other device known to those in the art, from which an appropriate replacement tire may be identified.

Once an appropriate replacement tire has been identified, the selected tire information may be entered into a tire selection entry center 52, or other device known to those in the art, to effectuate release of such tire from a tire retaining element 8. Alternatively, the selected tire 2 may be physically released from a tire retaining element 8 by manually removing a removable portion of the tire retaining element 8 such that the selected tire may be transferred to a tire servicing area 16. The selected tire 2 may then be transferred 54, preferably by passive transport as discussed above with reference to FIGS. 1 and 3, to a tire servicing area 16.

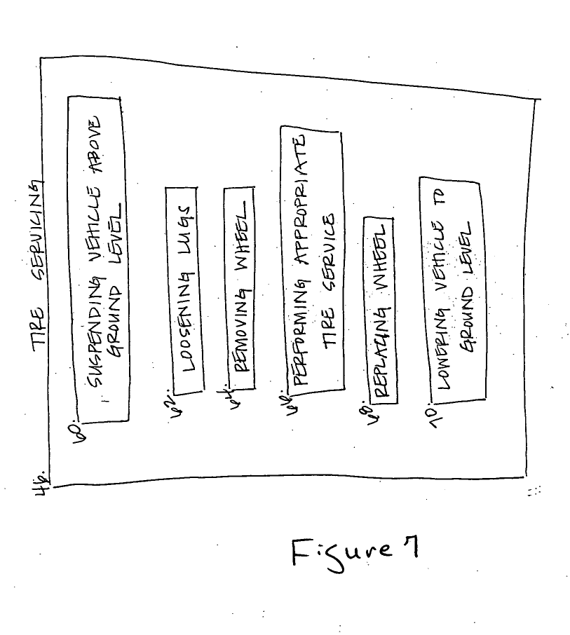

Referring finally to FIG. 7, tire servicing 46 in accordance with certain embodiments of the present invention may comprise first suspending a vehicle 4 above ground level by way of, for example, a jack 38 interposed between the vehicle and the tire servicing area surface 20. A service center employee 34 may then loosen lugs attached to the appropriate wheel 62, and proceed to remove the wheel 64. The tire 2 may then be serviced as desired 66, by, for example, rotating, replacing, inflating, repairing, balancing and/or examining the tire 2. Upon completion of the desired tire service 66, the service center employee 3 may replace the wheel onto the leveraged vehicle 4, and lower the jack 38 such that the vehicle 4 is thereby retained at ground level 70.

According to certain embodiments of the present invention, a tire servicing well 24 may be implemented on either side of a tire servicing lane 22 to further increase the efficiency of the tire servicing process 46. Indeed, in such case, one or more service center employees 34 may be situated in each well 24, thereby reducing the time associated with replacing all four vehicle tires by more than 50 percent, depending on the number of service center employees 34 thus situated and the number of tires 2 to be serviced. In addition, a tire servicing well 24 implemented on either side of a tire servicing lane 22 facilitates quick and efficient tire rotation, as a tire may be removed and replaced with an opposite tire in a matter of seconds as each service center employee 34 removes a tire and provides the removed tire to the service center employee 34 located in the opposite tire servicing well 24.

1. A method for replacing and servicing at least one tire disposed on a vehicle, said method comprising:
providing a tire servicing area comprising at least one tire servicing lane;
locating said vehicle substantially proximate said tire servicing lane;
providing at least one servicing well substantially adjacent said tire servicing lane, said well having a depth and width sufficient to accommodate a service center employee and maintain an ergonomic relationship between said vehicle and said employee;
servicing, by said service center employee, said at least one tire; and
directing said vehicle to exit said tire servicing area.

2. The method of claim 1, wherein said servicing further comprises performing a task selected from the group consisting of rotating said at least one tire, replacing said at least one tire, balancing said at least one tire, repairing said at least one tire, inflating said at least one tire, and examining said at least one tire.

3. The method of claim 2, wherein said rotating said at least one tire further comprises routing said at least one tire along a tire channel, wherein said tire channel substantially connects a first servicing well to a second servicing well, said second servicing well located substantially opposite said first servicing well.

4. The method of claim 1, wherein said directing said vehicle to exit said tire servicing area further comprises providing a service center employee at one end of said tire servicing area to personally and actively direct traffic.

5. The method of claim 1, wherein said directing said vehicle to exit said tire servicing area further comprises providing an electrical signal to direct traffic.

6. The method of claim 1, further comprising:
selecting at least one tire from a tire selection area located substantially above said tire servicing area;
releasing said at least one tire from said tire selection area such that said at least one tire may be received into said tire servicing area.

7. The method of claim 6, wherein said selecting at least one tire from a tire selection area further comprises processing, by a computer, information pertaining to said vehicle to identify said at least one tire.

8. The method of claim 6, wherein said releasing said at least one tire from said tire selection area further comprises channeling said at least one tire into a tire chute corresponding to said tire servicing area.

9. A system for replacing and servicing at least one tire disposed on a vehicle, said system comprising:
a tire selection area; and
a tire servicing area located substantially beneath said tire selection area, said tire servicing area having at least one lane, wherein said at least one lane comprises at least one servicing well located substantially adjacent each said lane.

10. The system of claim 9, wherein said tire selection area further comprises a tire chute substantially disposed between said tire selection area and said tire servicing area to translocate said at least one tire between said tire selection area and said tire servicing area.

11. The system of claim 9, wherein said tire selection area further comprises a customer waiting area for accommodating a customer while said vehicle is being serviced.

12. The system of claim 9, wherein said tire servicing area further comprises means for directing the entry and exit of said vehicle into said tire servicing area.

13. The system of claim 12, wherein said means for directing the entry and exit of said vehicle comprises a service center employee situated at a point of exit of said tire servicing area to direct traffic into and out of said tire servicing area.

14. The system of claim 12, wherein said means for directing the entry and exit of said vehicle comprises providing an electrical signal to direct traffic into and out of said tire servicing area.

15. The system of claim 9, wherein said at least one servicing well comprises a depth and width sufficient to accommodate a service center employee at an ergonomic level relative to said vehicle when said vehicle is located on said lane.
